(19) United States
(12) Patent Application Publication
(10) Pub. No.: US 2004/0230147 A1
(43) Pub. Date: Nov. 18, 2004

(54) Hand held massaging apparatus

(76) Inventor: Dino Fretterd, Norco, CA (US)

Correspondence Address: ROBERT J. SCHAAP, 21241 Ventura Boulevard, Suite 188, Woodland Hills, CA, 91364, US

(21) Appl. No.: 10/439,420

(22) Filed: May 15, 2003

(51) Int. Cl. A61H 7/00

(52) U.S. Cl. 601/135; 601/137

(57) ABSTRACT

A hand held massaging tool having a disc with a crowned upper surface which is adapted to fit in the palm of the hand of a user and a plurality of downwardly projecting tissue engaging projections, for engaging skin or muscle tissue of an animal or human being massaged. The projections are located around the periphery of the disc and are spaced apart from one another by recesses. Each of the projections also have sockets for receiving the fingers or thumb of a user. The fingers or thumb can also extend into the recesses for grasping of the massaging apparatus.

### BACKGROUND OF THE INVENTION

1. Field of the Invention

This invention relates in general to certain new and useful improvements in hand held massaging apparatus, and more particularly, to a hand held massaging apparatus which is adapted to comfortably fit within the palm of a user's hand and which allows for various hand holding positions, to eliminate arm or wrist fatigue of the user, and which still allows for application of a desired amount of pressure to the subject being massaged.

2. Brief Description of Related Art

There have been a large number of hand-held massaging apparatus available in the prior art. Each of these hand-held massaging apparatus presented limitations on their effectiveness and the ability for a user to hold the same for any extended duration of time. As a result, the user experienced either hand fatigue or wrist fatigue, or both.

In many cases, these massaging apparatus are used on either humans or animals, or both. When used on animals, a different amount of pressure may be required, compared to the use on a human subject. Moreover, in order to apply a differing amount of pressure, it was frequently necessary for the user to grasp and engage the hand-held massaging apparatus in a manner which was different than for use with a human being. The various prior art hand-held massaging apparatus did not fulfill these objectives. Consequently, the currently available and proposed hand-held massaging apparatus had limited functionality.

There has been at least one hand-held massaging apparatus for engagement in the palm of the hands of a user, and which may have had an appearance similar to that of the massaging apparatus of the present invention, but a functionality and efficiency which was far different from that of the apparatus of the present invention. U.S. Pat. No. 5,836,901 to Shenkal et al disclosed such a similar appearing, but differing, hand-held massaging apparatus. Indeed, the apparatus shown and described in the Shenkal et al. patent effectively highlights the differences between the massaging apparatus of the present invention and that represented by the prior art.

The device in the Shenkal et al., patent had a somewhat hemispherically shaped top surface, for engagement by the palm of a hand of a user. However, the device in the Shenkal, et al., patent only had four protrusions, or fingers, which projected outwardly therefrom, and downwardly with respect to the hemispherical surface of the body of the apparatus. The body of this prior art apparatus did not have suitable finger engaging recesses which retentively held the fingers in such recesses. This prior art device did use projections with cavities in those projections. However, there was not a combination of projections and recesses which could be used simultaneously. The functionality of the apparatus in the Shenkal et al. patent had a limited number of projections. The Shenkal, et al., patent was severely limited.

In addition to the foregoing, the cavities in the projection of the Shenkal, et al. patent were not properly sized to accept either the thumb or the fingers, or both, and moreover, due to the fact that there were only a maximum of four such projections, the apparatus in the Shenkal et al. patent was further limited. In substances, it has been found that to enable proper holding of the exercising apparatus, depending upon the conditions of use, it may be desirable to insert all of the fingers in the finger engaging cavities, or in the recesses around the periphery of the body, or otherwise, in some of the projections in the cavities and with some of the digits located in the recesses between the projections. This capability was just not present in the apparatus of the Shenkal et al. patent.

Although the apparatus in the Shenkal et al. patent had a somewhat similar appearance to the apparatus of the present invention, as aforesaid, the mere fact that it lacked these various features mentioned above severely limited the capability of that device. Consequently, it is apparent that Shenkal et al. did not appreciate the need for the combination of the recesses and the projections with cavities, and the need for a larger number of projections and recesses therefor.

As a result, there has been a need for a hand-held massaging apparatus, in which the user can hold the apparatus in different hand-held positions, depending upon the massaging conditions, to thereby eliminate or reduce the fatigue and the strain which results from holding an apparatus in a fixed hand-held position, and which did not allow for different massaging characteristics.

### OBJECTS OF THE INVENTION

It is, therefore, one of the primary objects of the present invention to provide a hand-held massaging apparatus, which is effective both for use on human beings and on various types of animals.

It is another object to provide a hand-held massaging apparatus of the type stated which allows for holding of the apparatus in a variety of positions, in order to accommodate different massaging characteristics.

It is a further object of the present invention to provide a hand-held massaging apparatus of the type stated, which enables various hand holding configurations to thereby eliminate or reduce fatigue to both the hands and the wrists of the user, and which thereby increases the overall ability to use the apparatus without creating damage or injury to the user thereof.

It is also an object of the present invention to provide a hand-held massaging apparatus of the type stated, which can be economically constructed, and which is therefore widely affordable and available for use.

It is another salient object of the present invention to provide a method of adjusting hand configurations for holding a hand-held massaging apparatus, depending upon the conditions of use, and to thereby avoid injury or damage to the user.

With the above and other objects in view, my invention resides in the novel features of form, construction, arrangement and combination of parts and components as presently described.

### BRIEF SUMMARY OF THE INVENTION

The present invention relates primarily to a hand-held massaging apparatus, generally referred to as a “tool,” capable of being moved across a subject which is being massaged, and without causing significant dysfunction to the hand or wrist, or even the arm, of a user of this hand-held massaging apparatus. The tool is comprised of a somewhat disc-shaped body, as hereinafter described in more detail, and with a plurality of subject engageable projections extending outwardly from the periphery of the body, also as hereinafter described in more detail.

The body of the apparatus is somewhat circularly shaped, and also has an arcuately shaped upper surface which is engageable by a palm of a user's hand. Thus, the upper surface of the body is essentially convex in shape. The disc presents a periphery, and integrally formed with the disc along this periphery, are a plurality of outwardly extending projections, which essentially extend downwardly from the upper surface of the disc or body, when in use, e.g., when the convex surface is presented upwardly. In a preferred embodiment of the invention, eight such projections are provided. Moreover, each of these projections have cavities which are sized to receive the thumb or fingers of a user's hand.

The aforesaid projections are equidistantly spaced around the periphery of the body or disc. Located between each of the projections is a recess formed in the periphery of the disc, and which is sized to comfortably receive the fingers or thumb of a user's hand. Thus, and in the preferred embodiment with eight projections, there are also provided eight such recesses.

The above outlined construction is effective for a hand-held massaging tool, in that it allows the user to engage the disc in the palm of the user's hand, since the disc has an upper surface somewhat conforming to the shape of the palm of a user's hand. Moreover, the user has the option of inserting his or her fingers and/or thumb into the various projection cavities, or into the various recesses, or both. Thus, depending upon the position of use, the user can engage the cavities in the projections with all of the digits of his or her hand, or all of the recesses with the digits of his or her hand. In like manner, the user can engage certain of the recesses and certain of the projection cavities, depending upon the conditions of use. In this way, since the user is capable of finding the optimum position, the possibility of fatigue in the hand and wrist is thereby reduced.

The entire hand-held massaging apparatus can be conveniently and inexpensively made from a variety of plastics in molding operations, such as injection molding operations, thermoforming operations, rotational molding operations, or the like. Plastics such as ethylinically saturated polymers, including polyethylene, polypropylene and the like could be used. However, it should be recognized that the massaging apparatus could be formed from a variety of other materials, including lightweight metals, composite materials, and the like.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a perspective view of a hand-held massaging tool, constructed in accordance with and embodying the present invention;

FIG. 2 is a top plan view of the tool of FIG. 1;

FIG. 3 is a bottom plan view of the massaging tool;

FIG. 4 is a side elevational view of the massaging tool;

FIG. 5 is a sectional view, taken along line 5-5 of FIG. 2; and

FIG. 6 is a side elevational view of the tool, similar to FIG. 4, and showing the position of a user's hand when grasping the tool of the invention.

### DETAILED DESCRIPTION OF A PREFERRED EMBODIMENT

Referring now in more detail and by reference characters to the drawings, there is provided a hand-held massaging tool, which is effective for the massaging of both animals and human beings by a user, without creating undue strain and resultant discomfort to the user.

The hand-held massaging tool A of the invention, comprises a body in the shape of a disc 10, having a somewhat circular shape 12, but which is provided with a plurality of grooves or recesses 14, along the periphery thereof. Each of these recesses 14 are equally spaced apart from one another, and generally have rounded edges where they merge into the periphery 12. Thus, from a top plan view, the periphery of the disc 10, in absence of any other structure, would appear to have an undulating round periphery.

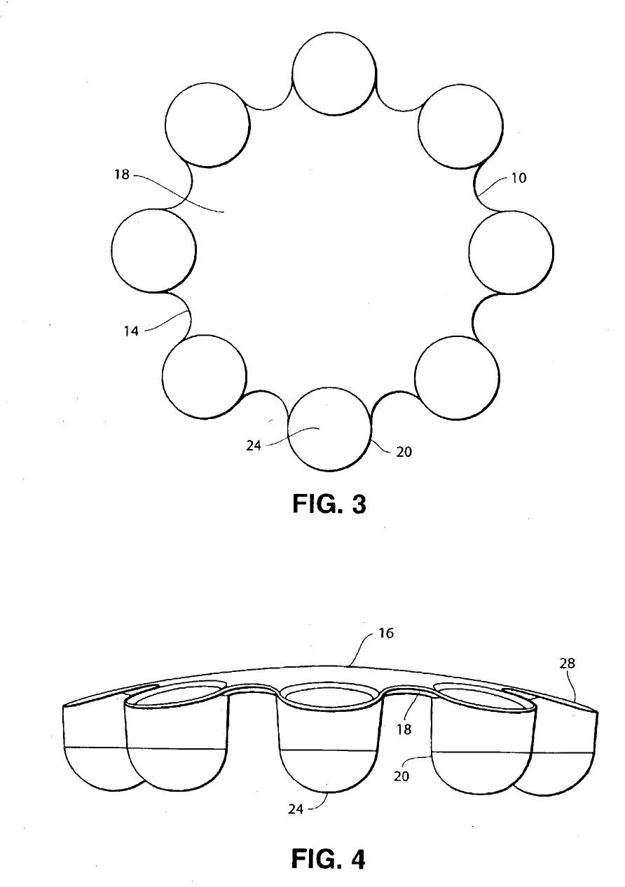

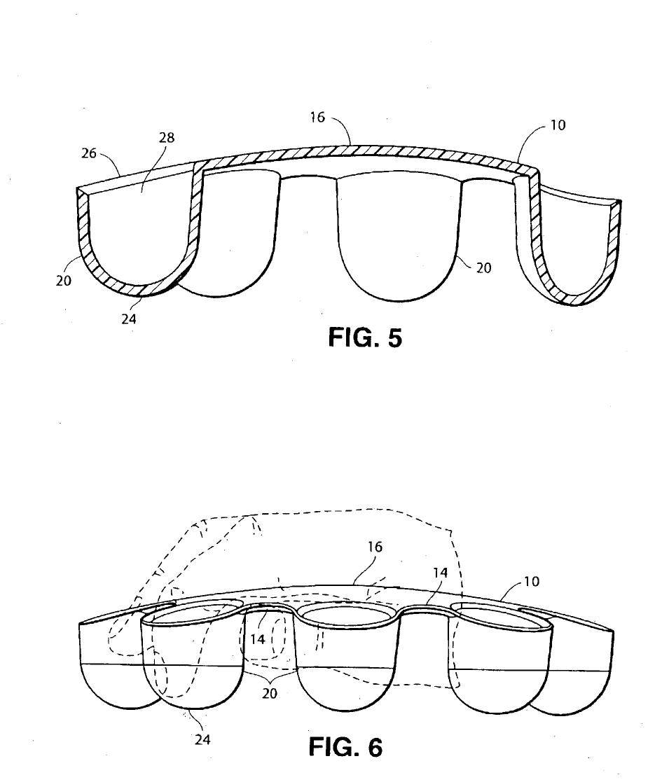

The disc 10 has an upper surface 16, as best shown in FIG. 4, which is somewhat convex in shape, preferably to engage the palm of a user's hand when the hand is slightly cupped. Inasmuch as the disc is formed of a single sheet of material, the bottom surface 18, as best shown in FIG. 3, would have somewhat of a concave shape. In this way, the bottom surface would not present an obstruction to the surface of an animal or a human being, when the massaging tool is used on a subject. For example, the concave surface of the bottom wall 18 would accommodate or receive a rounded edge of a shoulder portion of an individual, when the massaging tool is rubbed over that region of the subject's body.

Located on the peripheral edge 12 of the disc 10, are a plurality of projections 20, which extend generally outwardly away from the concave surface 18. Each projection 20 is in the form of a circularly shaped tube, having a rounded closed bottom surface 24, which is engageable with the subject's body. Thus, when the massaging tool is used, the rounded lower ends 24 will be in engagement with the subject's body and serve as the primary massaging surfaces.

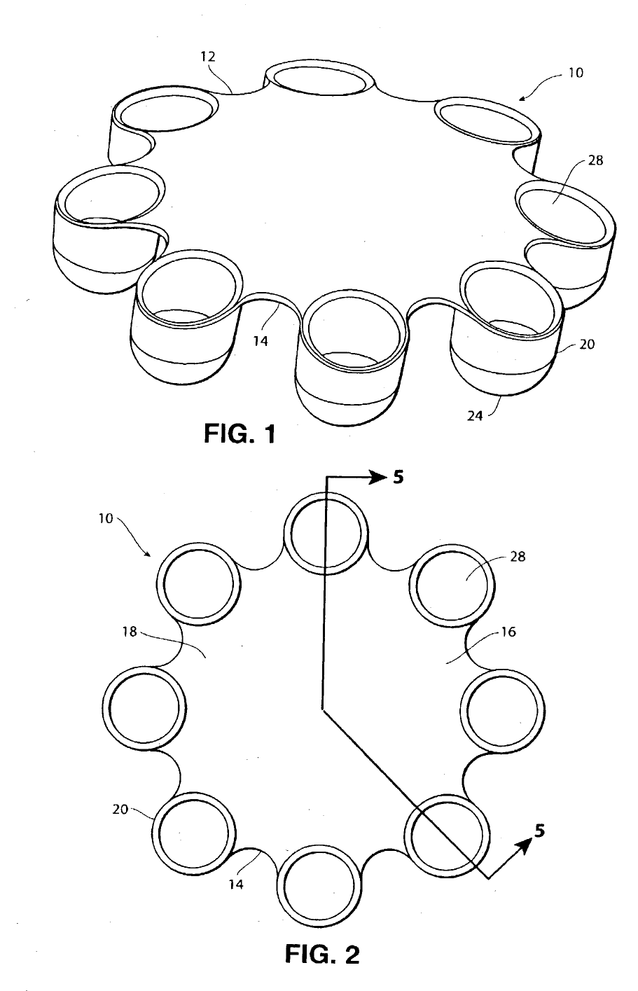

Each of the projections 20 extend outwardly from the disc 10, in a direction which are generally perpendicular with respect to the edge 12 of the disc 10, all in the manner as best shown in FIG. 1. Moreover, each of the projections 20 are provided with opened upper ends 26 leading into sockets or cavities 28, formed in the interior of each of the projections 20. It can also be observed that each of the projections are integral with the disc 10, and are located at the rounded ends of each of the recesses 14. Thus, the rounded shape of each of the projections 20 further aids, along with the recesses 14, in forming this undulating edge configuration.

Each of the cavities 28 and the open ends 26 are sized to receive the fingers or thumb of a user's hand. Moreover, the cross-sectional size is such that the fingers and thumbs will fit comfortably within the cavities, but without excessive space therein. Moreover, it can also be observed, particularly by reference to FIGS. 2 and 3 of the drawings, that each of the recesses 14 are similarly sized to comfortably receive the fingers or thumb of a user's hand.

Each of the cavities in the projections are sized to comfortably receive either a finger or a thumb of a user's hand. In this respect, the cross-sectional size of each of these cavities is sufficient to receive that finger or thumb of the user's hand without any pushable sidewise movement of the finger or thumb in that cavity. In this way, the user can comfortably hold the tool and move the same in a massaging pattern, without any slippage of the user's hand with respect to the tool. The same holds true of the recesses formed on the periphery of the tool. In this case, the recesses are similarly sized so as to comfortably receive a finger or thumb of the user's hand, without any appreciable sidewise movement. In this respect, the recesses have essentially the same arcuate shape and size a do the side walls of the cavity. In this respect, the recesses should preferably have an arcuate diameter of no more than about 1.5 times the arcuate diameter of the cavity in each of the projections.

It can be observed that in accordance with the above-outlined construction, the user can grasp the exercising apparatus by inserting digits of the user's hand in the recesses or in the cavities of the projections 20, or both. FIG. 6, for example, shows the position of a user's hand when certain of the digits are located within the recesses 14, and other of the digits are located in the cavities 28 of the projections 20. In the preferred embodiment of the invention, there are provided eight such recesses and correspondingly, eight projections 20. However, it should be understood that the number of projections and the number of recesses can vary, although it has been determined, in accordance with the present invention, that for efficiency and ease of operation, the number of recesses and correspondingly, the number of projections, should not be less than five. However, and as indicated, eight individual recesses and eight individual projections has been found to be the optimum number for efficiency in use of the massaging tool.

The hand-held massaging tool is formed so that it is fairly rigid and not readily deformable. It has been found that the overall shape and size of the apparatus is sufficient to conform to the hands of essentially all users, and that there is no need for any deformability of the exercising apparatus. Moreover, the materials of construction are selected so that the tool is very light in weight, preferably within the weight of 40 to 50 grams. In a preferred embodiment, when made of polypropylene, the tool is 43 grams in weight.

The massaging tool is effective in generating a relaxed and calm feeling in both humans and animals, when applied to the body of the subject. The apparatus may be rubbed against the body of the human or animals, and depending upon the degree of pressure which is applied, the tool will generate this relaxed sensation. As indicated, the tool fits comfortably within a user's hand. The massaging increases blood circulation in the body, and essentially, reduces tension, headaches, insomnia, anxiety, and back and nerve pain. The tool can be used for treatment of various injuries, including sports injuries, motor vehicle injuries, etc., by increasing localized circulation in the nerve areas and healing response.

One of the important aspects of the invention is that the tool can be used for a large number of massage techniques, such as will maximize myofascial release techniques, as well as effluerage, pertissage, acupressure, compression, etc.

Due to the fact that the tool has eight projections which engage the surface of the body in a massaging operation, the actual massaging tool substantially increases blood circulation in the body, and particularly in the region of the massage. This tool is also highly effective for treatment of tension, headaches, insomnia, anxiety, depression, back and neck pain, joint pain, and the like. The device can also be used with various injuries, and particularly, sports injuries or other orthopedic injuries, by increasing localized circulation in the area of that injury, which will enhance the healing response. Furthermore, the massaging tool will actually put pressure on an injured muscle and enervates an injured muscle, thereby inducing a more rapid recovery.

Thus, there has been illustrated and described a unique and novel hand held massaging apparatus and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what we desire to claim and secure by Letters Patent is:

1. A hand held massaging tool capable of being hand held and moved across a subject being massaged reducing the risk of dysfunction to the hand, wrist or arm of a user, said hand held massaging tool comprising:
a) a somewhat circularly shaped disc having an arcuately shaped surface engageable by a palm of a user's hand;
b) a plurality of subject engageable projections extending outwardly from an edge of said disc in a direction opposite to a crown of said arcuately shaped surface;
c) a cavity formed in each of said projections for receiving a finger or thumb of a user's hand, the cross-sectional size of each of said cavities being sufficient to comfortably receive the finger or thumb of a user's hand without any appreciable sidewise movement of the thumb or finger in said cavity enabling the user to comfortably hold the tool and move same in a massaging pattern without any slippage of the user's hand with respect to the tool; and
d) a plurality of grooves formed in an outer edge of sad disc and being sized to comfortably receive certain of the thumb or fingers of a user's hand.

2. The hand held massaging apparatus of claim 1 further characterized in that each of said projections have an open end adjacent said disc to receive digits of a user's hand and a closed opposite end.

3. The hand held massaging tool of claim 2 further characterized in that said grooves have a width less than sufficient to receive two or more digits of a user's hand.

4. The hand held massaging tool of claim 1 further characterized in that said arcuately shaped. surface comprises a segment of a hemisphere which if extended would form a complete hemisphere.

5. The hand held massaging tool of claim 2 further characterized in that said projections have an enclosing side wall and an end wall distal to the disc and which are closed with rounded ends to engage a subject being massaged.

6. The hand held massaging tool of claim 5 further characterized in that certain of said side walls of said projections provide circularly shaped interior cavities, and said projections have closed and rounded ends distal to said disc.

7. The hand held massaging tool of claim 4 further characterized in that said recesses have a diameter which is no greater than 1.5 times the diameter of the cavities in each of said projections.

8. The hand held massaging tool of claim 3 further characterized in that said recesses are sized and shaped so that said digits of a user's hand extend into said recesses in essentially the same direction as the digits which extend into the projections.

9. The hand held massaging tool of claim 3 further characterized in that said projections are generally equidistantly spaced apart from one another.

10. The hand held massaging tool of claim 1 further characterized in that said projections are located at a peripheral edge of said disc and extend outwardly away from said arcuately shaped surface.

11. The hand held massaging tool of claim 5 further characterized in that said disc has eight recesses and which are each separated by one of eight of said projections.

12. An improvement in a hand held massaging tool of the type having a hand held disc and being capable of being moved across a portion of a subject's body, the improvement in said massaging tool comprising:
a) a plurality of projections extending beyond said disc and having interior cavities sized to comfortably receive the fingers or thumb of a user's hand; and
b) a plurality of grooves formed in an outer edge of said disc for receiving certain digits of a user's hand and said grooves being sized and located to receive one or more other fingers or the thumb of a user's hand which are not located in said cavities and which fingers or thumb in the recesses extend in generally the same direction as the fingers or thumb in said cavities.

13. The improvement in the hand held massaging tool of claim 11 further characterized in that each of said projections have an open upper end to receive a user's fingers or thumb when extending into a cavity thereof.

14. The improvement in the hand held massaging tool of claim 12 further characterized in that said grooves have a width less than sufficient to receive two or more digits of a user's hand.

15. The improvement in the hand held massaging tool of claim 12 further characterized in that said projections each have an enclosing side wall and an end wall distal to said disc and the end walls of each of said projections engaging a subject being massaged.

16. The improvement in the hand held massaging tool of claim 12 further characterized in that said projections are located at a peripheral edge of said disc, and extend outwardly from a surface of said disc.

17. The improvement in the hand held massaging tool of claim 16 further characterized in that said projections and the bottom walls thereof are sufficiently sized so that they do not yield or deflect when the massaging tool is pressed against a subject's body with a generally normal amount of massaging force.

18. A method of holding a massaging tool and using the tool on a subject while reducing the risk of wrist and hand dysfunction when massaging a subject's body therewith, said method comprising:
a) engaging a convex surface of a disc forming part of the tool in a palm of a user's hand;
b) inserting or more fingers or a thumb of a user's hand into a plurality of individual cavities formed by finger engaging projections on an edge of said disc; and
c) locating one or more other fingers or thumb of a user's hand in recesses on the edge of said disc between the projections and causing the one or more fingers or thumb in the recesses to extend in the same general direction as the one or more fingers or thumb in the cavities of the projections.

19. The method of claim 18 further characterized in that said method further comprises bending the fingers at the cavities and at the recesses so that the one or more fingers in the projections are bent at approximately the same angle as the remainder of the one or more fingers at the recesses when holding the tool.

20. The method of claim 19 further characterized in that the method comprises locating ends of the projections against a subject's body.

21. The method of claim 18 further characterized in that said method comprises locating all fingers and a thumb of a user's hand in one of the recesses or one of the projections or both.

22. A hand held massaging tool capable of being hand moved across a subject being massaged without causing dysfunction to the hand, wrist or arm of a user, said hand held massaging tool comprising:
a) a somewhat cylindrically shaped disc having a convex top wall and a concave bottom wall with the top wall engageable by a palm of a user's hand during a massaging activity;
b) a plurality of subject engageable projections extending beyond an edge of said disc;
c) each of said projections extending away from the concave surface of said disc in a direction opposite to a crown of said convex surface;
d) a cavity formed in each of said projections to enable receipt of a finger of a user while engaging said tool and each cavity lead to an open end allowing receipt of a finger; and
e) a plurality of recesses located at the edge of said disc with each recess located between a pair of adjacent projections and with each recess sized to receive a finger not in a cavity of a projection and where each recess is located and sized so that fingers in the recesses extend in the same general direction as fingers in said cavities of said projections.

23. The hand held massaging tool of claim 22 further characterized that said recesses have a width less than sufficient to comfortably receive two or more digits of a user's hand.

24. The hand held massaging tool of claim 23 further characterized in that said projections have an enclosing side wall and a bottom wall, the latter of which engages a subject being massaged.

25. The hand held massaging tool of claim 24 further characterized in that said bottom wall of each of said projections is also arcuately shaped.

26. The hand held massaging tool of claim 22 further characterized in that said projections are generally equally spaced apart from one another.
